(19) United States
(12) Patent Application Publication
(10) Pub. No.: US 2009/0032135 A1
(43) Pub. Date: Feb. 5, 2009

(54) Fuel Supply method and fuel supply device

(76) Inventors: Yasuyuki Iida, Aichi (JP); Nobuo Kobayashi, Aichi (JP); Shigeo Yamamoto, Aichi (JP)

Correspondence Address: KENYON & KENYON LLP, 1500 K STREET N.W., SUITE 700, WASHINGTON, DC, 20005, US

(21) Appl. No.: 11/918,680

(22) PCT Filed: May 9, 2006
(86) PCT No.: PCT/JP2006/309618

§ 371 Date: Oct. 17, 2007

(30) Foreign Application Priority Data
May 9, 2005 (JP) 2005-135671

(51) Int. Cl. B60S 5/02; B67D 5/04; B60K 15/10; F17C 5/06; H01M 8/00; B60L 11/18

(52) U.S. Cl. 141/5; 429/22; 180/65.3; 141/69

(57) ABSTRACT

In order to enable fuel to be sufficiently supplied to a mobile object without requiring a power source outside the mobile object, a compressor is driven by power supplied from a fuel cell vehicle, and hydrogen emitted to gas piping from a pressure accumulator is supplied to a high-pressure hydrogen tank of the fuel cell vehicle side, in a method for supplying the hydrogen as a fuel gas to the high-pressure hydrogen tank mounted on the fuel cell vehicle from the pressure accumulator of the hydrogen station. A power-supplying operation required for driving the compressor is performed by at least a secondary battery or a fuel cell.

### BACKGROUND

The present invention relates to a fuel supply method for supplying fuel to a mobile object and a fuel supply device for carrying out same.

In recent years, a development of fuel cell vehicles where a fuel cell for generating power by means of an electrochemical reaction of fuel gas (for example, hydrogen) and oxidizing gas (air, for example) is mounted thereon as an energy source in replacement of engines is in progress. For example, as disclosed in the publication of Japanese Patent No. 3387070, a filling operation of the fuel for the fuel cell vehicles is performed at fuel-filling facilities such as a hydrogen station or the like. In the hydrogen station, a tank of the fuel cell vehicle is filled with the fuel which has been pressurized by means of a compressor.

### SUMMARY

Nevertheless, with the aforementioned hydrogen station, since an electric power is indispensably required for conducting filling of the fuel, in an area where the power supply is not available, or in a condition of a failure of the power supply at a time of a disaster or the like, the filling of the fuel cannot be achieved. In addition, although a mobile station employing a curdle in which hydrogen is filled in advance has been developed, the hydrogen can only be filled up to a state where a gas pressure in the vehicle reaches a pressure level equal to that of a pressure in the curdle at the time of the power failure.

The present invention is made in consideration of the above-described circumstances, and it is an object of the present invention to provide a fuel supply method and fuel supply device capable of sufficiently supplying fuel to a mobile object without necessity of any power source on the side of the fuel supply device outside the mobile object.

The present invention provides a fuel supply method for supplying or refueling the fuel to a mobile object, in which an electric power output from a power supply unit mounted on the mobile object to be capable of supplying the power is supplied to a fuel supply device arranged outside the mobile object, and the fuel is supplied to the mobile object by the fuel supply device operated with the electric power supplied from the power supply unit.

Further, the present invention provides a fuel supply device for supplying or refueling the fuel to a mobile object, which is provided with a fuel storage container mounted on the mobile object for storing fuel, a power supply unit mounted on the mobile object to be capable of supplying an electric power, a power outputting unit configured to output the electric power from the power supply unit to the fuel supply device arranged outside the mobile object for supplying or refueling the fuel to the fuel storage container, and a control unit configured to operate the fuel supply device by the electric power output from the power outputting unit.

According to the described configuration of the present invention, even at a time of occurrence of any power failure, or in an area where the power supply is not available, it becomes possible to supply the fuel to the mobile object from the fuel supply device arranged outside the mobile object.

Incidentally, in the aforementioned fuel supply method and the fuel supply device, a mobile object that receives the supply of the fuel from the fuel supply device arranged outside the mobile object, and a mobile object that supplies the electric power to the fuel supply device arranged outside the mobile object may be constituted by either the same mobile object, or separate mobile bodies.

Further, in the aforementioned fuel supply method and the fuel supply device, the electric power may be directly supplied from the mobile object to the fuel supply device outside the mobile object, however, in an alternative case where a stationary fuel cell is stationarily installed around the fuel supply device arranged outside the mobile object, so that the electric power is supplied to the fuel supply device from the stationary fuel cell, an electric power necessary for starting power generation by the stationary fuel cell may be supplied from the mobile object.

Currently, the “power necessary for starting power generation” refers to, for example, an electric power required for various kinds of checks (for example, a check for gas leakage) performed at the time of starting, an electric power necessary for operating diverse auxiliary devices (for example, a compressing operation for a cathode gas (oxidizing gas) or the like performed by means of the compressor), and for opening and closing an electromagnetic valve or the like disposed in a gas flow path, at the time of starting.

In the aforementioned fuel supply method, the power supply unit may also be a power storage device mounted on the aforementioned mobile object. Furthermore, in the aforementioned fuel supply device, the aforementioned power supply unit may also be a power storage device.

According to the described configuration, even in a case where a power generator is mounted on the mobile object so as to be capable of outputting electric power from the power generator, the electric power can be supplied to the fuel supply device arranged outside the mobile object without necessity of starting the power generator.

### DESCRIPTION OF DRAWINGS

FIG. 1 is a view schematically illustrating an embodiment of the present invention.

### DETAILED DESCRIPTION

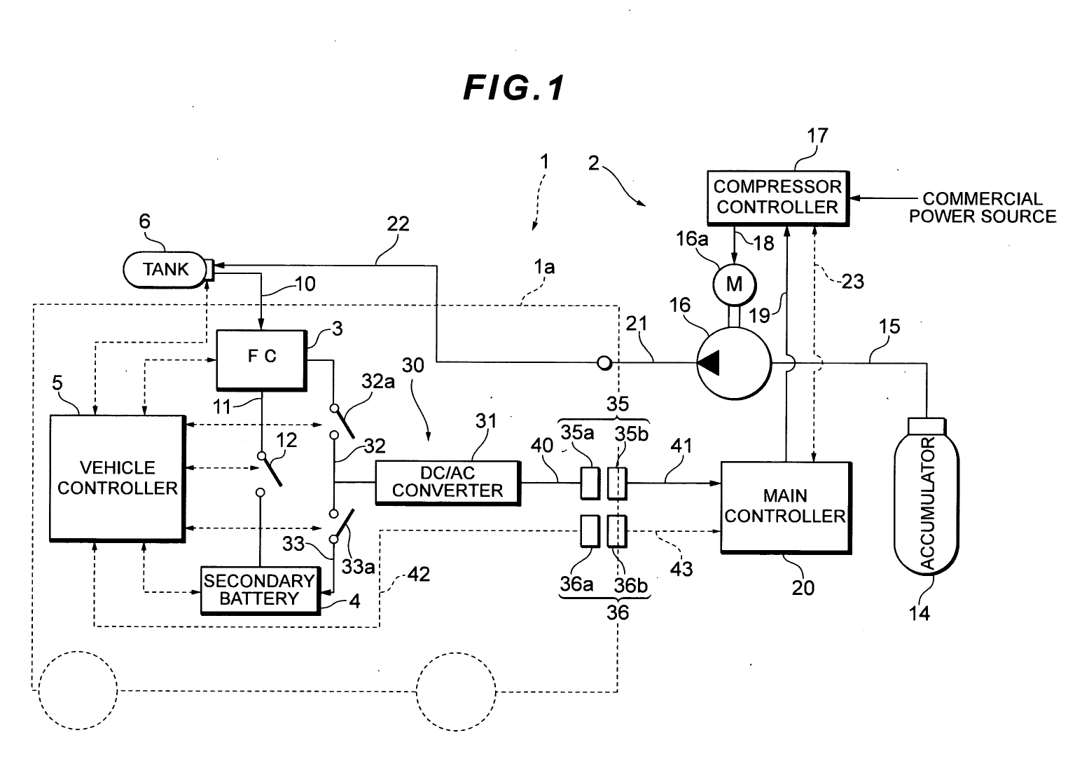

Next, an embodiment of the present invention will be described with reference to the drawing. The embodiment illustrated in FIG. 1 is a hydrogen-filling system for a fuel cell vehicle according to an embodiment of the present invention. In FIG. 1, the numeral 1 denotes a fuel cell vehicle (mobile object), and the numeral 2 denotes a hydrogen station.

The fuel cell vehicle 1 is provided, in a vehicular chassis 1a, with a fuel cell (power supply unit) 3, a secondary battery (a power supply unit, and a power storage device) 4 for storing the power generated by means of the fuel cell 3, and a vehicle controller 5, which controls an entire device and unit system provided for the fuel cell vehicle 1. As such a controlling operation given to the entire device and unit system, for example, a power generation controlling operation for the fuel cell 3, a charging control from the fuel cell 3 to the secondary battery 4, a power-feed controlling operation from the secondary battery 4 to electrical loads inside and outside the vehicle, and so forth are performed.

Outside the vehicle body 1a of the fuel cell vehicle 1, a high-pressure hydrogen tank (fuel storage container) 6 in which the hydrogen serving as the fuel for the fuel cell 3 is filled (supplied) is provided. The fuel cell 3 and the high-pressure hydrogen tank 6 are connected by means of a fuel supply path 10, and the hydrogen is supplied from the high-pressure hydrogen tank 6 to the fuel cell 3, via the fuel supply path 10.

The fuel cell 3 employs hydrogen supplied from the high-pressure hydrogen tank 6 as fuel gas, and generates an electric power by oxidizing the fuel gas with oxidizing gas supplied via an oxidizing gas (air) supplying system (not shown). The power generated by means of the fuel cell 3 is charged in the secondary battery 4 via a output-wiring 11. Incidentally, a switch 12 is disposed in the output-wiring 11, to thereby control the charging operation of the electric power by appropriately turning on or off the switch.

The hydrogen station 2 is provided with a pressure accumulator 14 in which the hydrogen is encapsulated, a compressor (fuel supply device) 16 for compressing (pressurizing) the hydrogen discharged from the pressure accumulator 14 to gas piping 15 to thereby supply the fuel cell vehicle 1 with the pressurized hydrogen, and a compressor controller (control unit) 17 for controlling the compressor 16. The compressor 16 is provided with a motor 16a, and the power is supplied to the motor 16a from the compressor controller 17 via an electric wiring 18.

Further, the hydrogen station 2 is provided with a main controller (control unit) 20 for controlling an entire facility system including the compressor controller 17. The compressor controller 17 is supplied with electric power from an external commercial power source, and the electric power is also supplied to the main controller 20 from the compressor controller 17 via an electric wiring 19. Incidentally, in a case where the present fuel filling system is stationarily installed in an area where the supply power is not available, no commercial power is supplied to the compressor controller 17.

The main controller 20 is connected to the compressor controller 17 by means of a control signal line 23, and a control signal is given to the compressor controller 17 from the main controller 20 via the control signal line 23, and an error-signal checking signal is returned back to the main controller 20 from the compressor controller 17.

Filling of the hydrogen from the compressor 16 into the high-pressure hydrogen tank 6 mounted on the fuel cell vehicle 1 is performed by means of a gas supply pipe 21 detachably attached to the fuel cell vehicle 1. When filling the hydrogen, the gas supply pipe 21 is connected to a gas supply pipe 22 on the side belonging to the fuel cell vehicle 1, and the hydrogen discharged to the gas piping 15 from an inside of the pressure accumulator 14 is compressed by means of the compressor 16, and is filled into the high-pressure hydrogen tank 6 via the gas supply pipes 21 and 22.

The following construction is provided as a power outputting unit 30 in the fuel cell vehicle 1 and the hydrogen station 2. The fuel cell vehicle 1 is provided with a DC/AC converter 31 for performing a DC/AC conversion for the power supplied to the main controller 20 from the fuel cell vehicle 1, a power supply wiring 32 for supplying the electric power to the DC/AC converter 31 from the fuel cell 3 and a switch 32a disposed in the power supply wiring 32, and a power supply wiring 33 for supplying the electric power to the DC/AC converter 31 from the secondary battery 4 and a switch 33a disposed in the power supply wiring 33.

In addition to the above-described construction, the power outputting unit 30 is further provided with a power feeding device 35a constituting a power feeding side of a noncontact power feeding device 35 for feeding the electric power to the hydrogen station 2 from the fuel cell vehicle 1 in a noncontact manner, and a transmitter-receiver 36a on the fuel cell vehicle side of a noncontact-type signal transmitting and receiving device 36 for similarly connecting a signal line in the noncontact manner.

The hydrogen station 2 is provided with a power receiving device 35b of the noncontact power feeding device 35, and a transmitter-receiver 36b on the hydrogen station side of the noncontact-type signal transmitting and receiving device 36. The noncontact power feeding device 35 and the noncontact-type signal transmitting and receiving device 36 can adopt the well known art, for example, a noncontact power feeding method by which the electric power is dielectrically induced due to the dielectric operation. The transmitting and receiving operation for the signal using the noncontact-type signal transmitting and receiving device 36 can be implemented depending on an intensity of the electric power, i.e., depending on whether the power is small or large. Incidentally, when the power receiving device 35b and the transmitter-receiver 36b are assembled together in a single integral connector, the same can be connected to the fuel cell vehicle 1 side by one time of operation.

Electrical connection between the DC/AC converter 31 and the main controller 20 can be provided by means of a power feeding line 40, noncontact power feeding device 35, and a power feeding line 41, and electric connection between the vehicle controller 5 and the main controller 20 can be provided by a signal line 42, noncontact type signal transmitting and receiving device 36, and a signal line 43.

Incidentally, the vehicle controller 5 controls each of components (fuel cell 3, secondary battery 4, high-pressure hydrogen tank 6, switches 12, 32a, 33a, and so forth) of the fuel cell vehicle 1. Control signals indicated by broken lines are transmitted to the respective components from the vehicle controller 5, and the error signal checking signals are returned back to the vehicle controller 5 from the respective components.

When the vehicle is running, the vehicle controller 5 of the fuel cell vehicle 1 appropriately closes the switch 12 according to a request for storing the power set on the basis of a running condition of the vehicle, state of charge (SOC) of the secondary battery 4 and so forth, and hence a part of or all of the power generated by means of the fuel cell 3 is stored in the secondary battery 4.

Next, a method for filling the hydrogen to the fuel cell vehicle 1 in the present hydrogen-filling system will be described hereinbelow.

<Filling Operation at a Time when the Power of the Commercial Power Source is Distributed>

When the power is normally distributed (in a condition such that the commercial power is supplied to the compressor controller 17), firstly, a user connects the gas supply pipe 21 with the gas supply pipe 22 on the fuel cell vehicle 1 side. The main controller 20 drives the motor 16a via the compressor controller 17. Consequently, the hydrogen discharged from the pressure accumulator 14 to the gas piping 15 is compressed to a predetermined pressure level by means of the compressor 16, and is filled into the high-pressure hydrogen tank 6 of the fuel cell vehicle 1 side. After the filling operation is completed, the user disconnects the gas supply pipe 21 from the gas supply pipe 22.

### <Filling Operation at a Time of a Power Supply Failure>

In a case that the commercial power source is stopped due to a power supply failure at a time of a disaster or the like, or that the power supply is not inherently available, the following filling operation is performed. Firstly, the user connects the gas supply pipe 21 with the gas supply pipe 22 of the fuel cell vehicle 1 side. Further, the user connects the power receiving side 35b of the noncontact power feeding device 35 with the power feeding side 35a, and the transmitter-receiver 36b of the hydrogen station 2 side of the noncontact-type signal transmitting and receiving device 36 with the transmitter-receiver 36a of the fuel cell vehicle side.

The vehicle controller 5 connects the secondary battery 4 with the DC/AC converter 31 by turning off the switch 32a and turning on the switch 33a. Hence, the power stored in the secondary battery 4 is fed to the main controller 20 from the DC/AC converter 31 via the noncontact power feeding device 35. The main controller 20 is connected to the vehicle controller 5 by means of the noncontact-type signal transmitting and receiving device 36, and the control signal required for receiving the power is transmitted and received between the vehicle controller 5 and the main controller 20.

The main controller 20 feeds an electric power to the compressor controller 17 via the wiring 19, and further provides a control signal for filling to the compressor controller 17 via the control signal line 23. The compressor controller 17 compresses the hydrogen discharged from the pressure accumulator 14 to the gas piping 15 to a predetermined pressure level by means of the compressor 16, and fills the same into the high-pressure hydrogen tank 6 in a similar manner as that in the aforementioned case in which the power is normally distributed.

Thus, in a case that the commercial power source is stopped due to the power supply failure, or even in a case that the power supply is not inherently available, the hydrogen can be filled into the high-pressure hydrogen tank 6 of the fuel cell vehicle 1. Specifically, in the present embodiment, the hydrogen can be filled into the high-pressure hydrogen tank 6 up to a maximum extent by compressing the hydrogen by means of the compressor 16.

Incidentally, since the secondary battery 4 is usually charged in a sufficient condition for feeding the power, the feeding operation is performed by using the secondary battery 4 as a power source in the aforementioned example. However, in a case that the remaining capacity of the secondary battery 4 is not sufficient (for example, 40% or less), or the like, the fuel cell 3 may be used as a power source. In this case, the power is generated by means of the fuel cell 3 and the switch 32a is turned on and the switch 33a is turned off. Furthermore, if both the secondary battery 4 and the fuel cell 3 are simultaneously used, a far rapid filling operation can be realized.

Moreover, in the aforementioned configuration, although a noncontact power feeding method of an induction type is adopted as a power feeding method for feeding the electric power to the hydrogen station 2 from the fuel cell vehicle 1, the method other than the noncontact type may be applicable. In this case, the feeding lines 40 and 41, and the signal lines 42 and 43 are really connected between the fuel cell vehicle 1 and the hydrogen station 2 using a connector or the like.

### OTHER EMBODIMENTS

The present invention is applicable to embodiments other than that described above by making various modifications therein. For example, as the fuel storage container, a hydrogen-gas absorbing alloy, a high-pressure tank, fuel tank and the like can be adopted. As a power supply unit, for example, a fuel cell, a hybrid system of an engine and a power generator, a generator represented by a solar cell or the like, or, for example, a power storage device represented by a battery, a condenser, or the like can be adopted.

As the mobile object, for example, vehicles, boats and ships, robots, and mobile terminals or the like can be adopted. As the fuel supply device, for example, a supply pump and a temperature controller (for example, for use in the hydrogen-gas absorbing alloy) can be adopted.

Further, in the aforementioned embodiment, although the fuel cell vehicle 1 that receives the supply of the hydrogen from the hydrogen station 2 and the fuel cell vehicle 1 that supplies electric power to the hydrogen station 2 serve as the same fuel cell vehicle 1, these fuel cell vehicles 1 may consists of separate fuel cell vehicles 1.

Furthermore, in the aforementioned embodiment, although the electric power is directly supplied to the compressor 16 from the fuel cell vehicle 1 via the main controller 5 and the compressor controller 17, in a case that a stationary fuel cell, such as for example, a PEMFC, a PAFC, or the like, is stationarily installed in the hydrogen station 2, and that the electric power is arranged to be supplied from the stationary fuel cell to the compressor 16, the power for starting the power generation of the stationary fuel cell may be supplied from the fuel cell vehicle 1.

Incidentally, as an example of “power for starting power generation”, it refers to the power required for various kinds of checks (for example, a check for gas leakage) performed at the time of starting, the power required for each of operations of auxiliary devices (for example, a compressing operation for a cathode gas (oxidizing gas) or the like performed by means of the compressor), and for opening and closing and the like of an electromagnetic valve set in a gas flow path, or the like at the time of starting.

According to the present invention, fuel can be supplied to a mobile object even in an area where the power supply is not available, or at a time of a power supply failure. In addition, by using the power storage device mounted on the mobile object as a power source, the fuel can be supplied without starting the power generator even when the power generator is mounted on the mobile object.

Therefore, the present invention can be widely utilized for methods for supplying the fuel, and for fuel supply devices having such a demand.

We claim:

1. A method for supplying fuel to a mobile object comprising the steps of:
supplying an electric power output from a power supply unit mounted on the mobile object to be capable of supplying the electric power to a fuel supply device arranged outside the mobile object; and
supplying the fuel to the mobile object by operating the fuel supply device with the electric power output from the power supply device.

2. The method for supplying the fuel according to claim 1, wherein the power supply unit comprises a power storage device mounted on the mobile object.

3. A fuel supply device for supplying fuel to a mobile object comprising:
a fuel storage container mounted on the mobile object and configured to store the fuel, and;
a power supply unit mounted on the mobile object to be capable of supplying electric power, and;
a power outputting unit configured to output the power from the power supply unit to the fuel supply device arranged outside the mobile object that supplies the fuel to the fuel storage container; and
a control device configured to operate the fuel supply device by the electric power output from means of the power outputting unit.

4. The fuel supply device according to claim 3, wherein the power supply unit comprises a power storage device.
